(19) United States
(12) Patent Application Publication
(10) Pub. No.: US 2021/0320859 A1
(43) Pub. Date: Oct. 14, 2021

(54) AN ARCHITECTURE FOR MANAGING IPV4 BASED CUSTOMER PREMISSES EQUIPMENTS THROUGH IPV6

(71) Applicant: TURKCELL TEKNOLOJI ARASTIRMA VE GELISTIRME ANONIM SIRKETI, Istanbul (TR)

(72) Inventors: Umut YAZICI, Istanbul (TR); Salih MEMICI, Istanbul (TR); Can UCMAK, Istanbul (TR); Murat AKIN, Istanbul (TR); Ozge GURE, Istanbul (TR); Tayfun OZALTIN, Istanbul (TR); Ercin TORUN, Istanbul (TR); Mehmet Ferhat MERIC, Istanbul (TR); Mert KOCASARI, Istanbul (TR); Murat KARAARSLAN, Istanbul (TR); Yunus OT, Istanbul (TR)

(73) Assignee: TURKCELL TEKNOLOJI ARASTIRMA VE GELISTIRME ANONIM SIRKETI, Istanbul (TR)

(21) Appl. No.: 17/266,900

(22) PCT Filed: Aug. 8, 2018
(86) PCT No.: PCT/TR2018/050420

§ 371 Date: Feb. 8, 2021

(51) Int. Cl. H04L 12/733; H04L 12/803; H04L 12/749; H04L 12/723; H04W 40/04; H04W 28/08

(52) U.S. Cl. CPC H04L 45/122; H04L 47/125; H04W 28/0823; H04L 45/50; H04W 40/04; H04L 45/741

(57) ABSTRACT

The present invention is basically related to a system which is For managing IPv4 based network through IPv6 based TR-069 communication and which provides a solution allowing new subscriber registrations to the networks that has reached maximum number of IP (Internet Protocol) usage.

### TECHNICAL FIELD

The present invention is basically related to a system which is For managing IPv4 based network through IPv6 based TR-069 communication and which provides a solution allowing new subscriber registrations to the networks that has reached maximum number of IP (Internet Protocol) usage.

### BACKGROUND OF THE INVENTION

In the state of the art, the whole range of IPv4 addresses are in use worldwide, so existing IPv4 resources are insufficient to cover the network needs. Therefore the companies who has the role of a service provider are not able to acquire new IP addresses to be used for their services. The fact that the private IP blocks that are being used in CGN (Carrier-grade NAT) structure is common among the all ISPs (Internet Service Provider) causes the size of the problem in the prior art get bigger and it also prevents the ISPs from conducting collaborative work for infrastructure sharing.

To overcome these problems, within a solution in the state of the art, MPLS (Multiprotocol Label Switching) network has been divided into different VRFs (Virtual Routing and Forwarding) and in order to use same IP addresses in each VRF, a new ACS (Auto Configuration Server) management platform has been deployed to each VRF. By this solution, as long as the VRF number increases, the cost also increases. In addition to the increase in the cost, conducting operational actions becomes more difficult and the whole management of the network becomes more complex.

Another solution to the network management problem in the prior art is a proxy-based solution. In this solution, different proxy server that identifies each VRF are deployed before the ACS. As one skilled in the art can understand, this solution requires more proxy servers to be deployed as the number of VRFs Increases. In addition to this deployment requirement problem there is also a restriction problem in this solution about the number of maximum sessions and devices that a proxy server can support. When considered with the backup scenarios, it becomes more obvious that the whole management system in this solution becomes one which is difficult and complex to manage.

The United States patent document no. US20050025157A1, an application in the state of the art, discloses certain exemplary embodiments which provide a method for converting data packets based upon IPv4 protocol into data packets based upon IPv6 protocol, said method comprising converting any data packet based upon the IPv4 protocol into a data packet based upon the IPv6 protocol before transmitting it to an IP switched network using information provided by an external server, and converting any data packet based upon the IPv6 protocol provided by said IP switched network into a data packet based upon the IPv4 protocol before transmitting it to a first or second workstation.

The United States patent document no. US20040088385A1, an application in the state of the art discloses a tunnel setup protocol which enables tunnel clients to set up IPv4-in-IPv6 tunnels to permit IPv4 nodes to communicate across the IPv6 network using IPv4 native packets. The tunnel setup protocol is a control channel for negotiating tunnel configuration parameters and exchanging tunnel configuration data between a tunnel client and a tunnel broker server. The tunnel setup is automatic, support of IPv4 nodes and networks in IPv6 networks is enabled, and support of IPv4 devices after migration to IPv6 is facilitated.

### SUMMARY OF THE INVENTION

An objective of the present invention is to manage IPv6 based network architecture and provide a solution allowing new subscriber registrations and growth in the IPv4 network by reuse of IPv4 addresses to the networks that has reached maximum number of IP (Internet Protocol) usage.

Another objective of the present invention is to provide a flexible, scalable and secure solution which will allow the Internet Service Providers to conduct service activation management and monitoring over Auto Configuration Server management platform and without dealing with IP address conflicts. Such solution is especially useful for ISPs when remote service activation, management and monitoring of the technical KPIs (Key Performance Indicator) of CPE (Customer Premises Equipment) devices which are able to provide fixed and mobile broadband network service, STB (Set-Top-Box) devices and LTE (Long Term Evolution) router devices is conducted with TR-069 protocol and its variants.

### DESCRIPTION OF THE INVENTION

A System for Managing IPv6 Based Network realized to fulfill the objectives of the present invention is shown in the figures attached, in which:

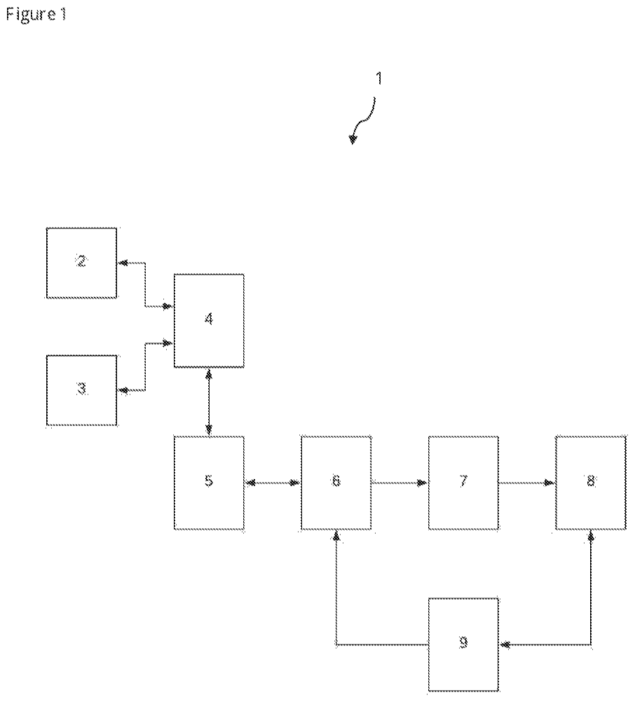

FIG. 1 is a schematic block diagram of the inventive system.

The components illustrated in the figures are individually numbered, where the numbers refer to the following:
1. System
2. CPE-A
3. CPE-B
4, MPLS Router
5. CGN
6. Firewall
7. Load Balancer
8. ACS Load Balancer
9. ACS

A system (1) which enables managing IPv6 based network:
at least one CPE-A (2) which is the primary customer device being activated, maintained monitored for accessing services which are offered by the service provider via sending and receiving data packets,
at least one CPE-B (3) which is the secondary customer device being activated, maintained, monitored for accessing services which are offered by the service provider via sending and receiving data packets,
at least one MPLS router (4) which directs data from one network node to the next based on short path labels,
at least one CGN (5) which manipulates the data packets which are originated by and destined to CPE-A (2) and CPE-B (3),
at least one firewall (6) which communicates with CGN (5) and operates in IPv6 mode,
at least one load balancer (7) which receives data packets from the firewall (6),
at least one ACS load balancer (8) which receives the data packets from the load balancer (7),
at least one ACS (9), which is enabled to receive the data packets which are originated by CPE-A (2) and CPE-B (3) and send data packets to CPE-A (2) and CPE-B (3); and which records IPv4 addresses that are used by CPE-A (2) and CPE-B (3) while sending the data packets, IPv6 addresses which is obtained by the transformation of said IPv4 address and device serial numbers of CPE-A (2) and CPE-B (3) so that it will be able to access CPE-A (2) or CPE-B (3) at any specific time and for any specific objective (FIG. 1).

CPE-A (2) is the primary customer device being activated, maintained, monitored for accessing services which are offered by the service provider via sending and receiving data packets

CPE-B (3) is the secondary customer device being activated, maintained, monitored for accessing services which are offered by the service provider via sending and receiving data packets.

In different embodiments of the invention, CPE-A (2) and CPE-B (3) are the devices which are able to provide fixed and mobile broadband network service or STB (Set-Top-Box) devices or LTE (Long Term Evolution) router devices.

MPLS router (4) is the component which directs data from one network node to the next based on short path labels.

CGN (5) is the component which manipulates the data packets which are originated by CPE-A (2) and CPE-B (3).

Firewall (6) is the component which communicates with CGN (5) and operates in IPv6 mode.

Load balancer (7) is the component which receives data packets from the firewall (6).

ACS load balancer (8) is the component which receives the data packets from the load balancer (7) and transmits them to ACS (9) based on the load and the redundancy of servers.

ACS (9) is the component which receives the data packets which are originated by CPE-A (2) and CPE-B (3) and which records IPv4 addresses that are used by CPE-A (2) and CPE-B (3) while sending the data packets, IPv6 address which is obtained by the transformation of said IPv4 address and device serial numbers of CPE-A (2) and CPE-B (3) so that it will be able to access CPE-A (2) or CPE-B (3) at any specific time and for any specific objective.

Within the operation of the system (1) which is disclosed in the present invention, firstly, CPE-A (2) and CPE-B (3) originates HTTP/HTTPs data packets with the same source IPv4 addresses via MPLS routers (4) and the different VRFs. The destination address for the related data packets is the virtual IP address of the load balancer (7). Related data packets are manipulated by CGN (5) so that the both source and the destination address of the data packets are changed to IPv4 and IPv6 accordingly. And this is being done on CGN (5) statelessly meaning no session information is kept on CGN device. According to the IP address blocks used return packets can also be identified Same source IPv4 addresses for data packets originated by CPE-A (2) and CPE-B (3) are translated by CGN (5) to different IPv6 addresses respectively and the destination address for the related data packets are translated by CGN (5) to the IPv6 address of the load balancer (7). In this structure IPv4 subscribers access a source of IPv6 (ACS etc) and access type is bidirectional. On the IPv6 side, a certain /96 prefix is selected and used for conversion. When an IPv4 address reaches an IPv6 source (for example, ACS) on this address, its address is embedded in the IPv6 address. For example, if modem IP is 10.1.123.143, this IPv4 address is buried in the last hex and translated to IPv6:

| 2096:db8:aa:1::0a1:7b8f | |
|---|---|
| 10 Y | 0a |
| 1 Y | 1 |
| 123 Y | 7b |
| 143 Y | 8f |

Related data packets which have IPv6 source and destination addresses after NAT (Network Address Translation) process are sent from the related VRF partition of CGN (5) to the firewall (6) via different V LANs. For the firewall (6), V LANs, which are the same number as the number of partitions in CGN (5), are specified so that the every VRF partition of CGN (5) becomes discrete.

The firewall (6) which operates in IPv6 mode transmits the data packets to the load balancer (7) which is the destination point for the data packets. Load balancer (7) writes the source IPv6 address of the data packet to the XFF value for each data packet so that ACS (9) will be enabled to read IPv6 address values for CPE-A (2) and CPE-B (3) in order to match the device and IP address while database related processes are conducted.

After writing the source IPv6 address of the data packet to the XFF value, the load balancer (7) transmits the data packets to the ACS load balancer (8) which is the part of the ACS (9) and which can communicate on IP level. ACS load balancer (8) is responsible for transmitting data packets to any one of the ACSs (9) based on the load and redundancy of the servers. As the data packets reach ACS (9), they are extracted and being processed on application layer. Since the data packets originated by CPE-A (2) and CPE-B (3) have IPv4 addresses when they are first transmitted by CPE-A (2) and CPE-B (3), the IPv4 addresses are placed on network layer. However, ACS (9) is able to read IP address in XFF value which is on application layer (7).

Since ACS (9) can both read the original source IPv4 address from TR69 packet along with the IPv6 address which has been written on XFF value by the load balancer (7), it can record the following information in mapped format to its database: the device serial numbers of CPE-A (2) and CPE-B (3), the original source IPv4 address of the data packets originated by CPE-A (2) and CPE-B (3) and the respective IPv6 addresses of data packets which has been written on XFF value by the load balancer (7). This enables ACS (9) to read IPv6 address corresponding to any CPE, such as CPE-A (2) and CPE-B (3), by using the related device serial number and forwarding the correct data packet to the correct CPE device.

While ACS (9) is reaching CPE-A (2) and CPE-B (3) for service activation, management and monitoring purposes, data packets originated by ACS (9) are transmitted by ACS (9) directly to the firewall (6). Firewall (6) receives data packet and transmits it to the related partition of CGN (5) over VLAN. In order to conduct this transmission, firewall (6) modifies the source IPv6 address value of the data packet (Source NAT) and replaces the IPv6 address of the load balancer with this source IPv6 address so that CGN (5) will be able to conduct the reverse process of network address translation which has occurred during the data packet transmission from CPE-A (2) and CPE-B (3) to ACS (9). By this implementation of the invention, firewall (6) is enabled to operate in full transparent mode and whole management architecture is enabled to have flexibility. For the Source NAT process, ARP inform packets are disabled in the firewall (6), in this implementation of the invention.

As soon as the data packet originated by ACS (9) is transmitted to CGN (5), CGN (5) extracts the data packet based on VLAN number over which the data packet has been transmitted and receives the data packet from the related partition. IPv6 address in the data packet has been translated to IPv4 address by CGN (5) for both source and destination addresses so that CPE-A (2) and CPE-B (3) can receive data packet in IPv4 format as they expected to receive.

With the architecture provided by the implementation of the present invention, ACS (9) is enabled to communicate with OSS/BSS layer over IPv4. The first application on the said OSS/BSS layer is the CRM (Customer Relationship Management) system of the service provider company and CRM system is enabled to access ACS (9) over a discrete VLAN and in IPv4 format. Similar to CRM application, the ACS application which provides information and actions to call center screens is also enabled to access ACS (9) over a discrete V LAN and in IPv4 format.

It is possible to develop various embodiments of the inventive system (1), it cannot be limited to examples disclosed herein and it is essentially according to claims.

1. A system (1) which enables managing IPv4 based network through IPv6 based TR-069 communication comprising
at least one CPE-A (2) which is the primary customer device being activated maintained, monitored for accessing services which are offered by the service provider via sending and receiving data packets with the same external IP address of CPE-B (3),
at least one CPE-B (3) which is the secondary customer device being activated, maintained, monitored for accessing services which are offered by the service provider via sending and receiving data packets with the same external IP address of CPE-A (2),
at least one MPLS router (4) which directs data from one network node to the next based on short path labels,
at least one CGN (5),
at least one firewall (6) which communicates with CGN (5) and operates in IPv6 mode,
at least one load balancer (7) which receives data packets from the firewall (6),
at least one ACS load balancer (8) which receives the data packets from the load balancer (7) and characterized by
at least one CGN (5) which manipulates the data packets which are originated by and destined to CPE-A (2) and CPE-B (3),
at least one ACS (9), which is enabled to receive the data packets which are originated by CPE-A (2) and CPE-B (3) and send data packets to CPE-A (2) and CPE-B (3); and which records IPv4 addresses that are used by CPE-A (2) and CPE-B (3) while sending the data packets, IPv6 addresses which is obtained by the transformation of said IPv4 address and device serial numbers of CPE-A (2) and CPE-B (3) so that it will be able to access CPE-A (2) or CPE-B (3) at any specific time and for any specific objective.

2. A system (1) according to claim 1, characterized by CPE-A (2) which is a device to provide fixed and/or mobile broadband network service or STB (Set-Top-Box) device or LTE (Long Term Evolution) router device.

3. A system (1) according to claim 1, characterized by CPE-B (3) which is a device to provide fixed and/or mobile broadband network service or STB (Set-Top-Box) device or LTE (Long Term Evolution) router device.

4. A system according to claim 1, characterized by CGN (5) which modifies the data packets originated by CPE-A (2) and CPE-B (3) so that same source IPv4 addresses for data packets originated by CPE-A (2) and CPE-B (3) are translated to different IPv6 addresses respectively and the destination address for the related data packets are translated to the IPv6 address of the load balancer (7).

5. A system according to claim 1, characterized by the load balancer (7) which writes the source IPv6 address of the data packet to the XFF value for each data packet so that ACS (9) will be enabled to read IPv6 address values for CPE-A (2) and CPE-B (3) in order to match the device and IP address while database related processes are conducted.

6. A system according to claim 1, characterized by ACS (9) which is able to read the original source IPv4 address from TR69 packet along with the IPv6 address which has been written on XFF value by the load balancer (7) and which can record the following information in mapped format to its database: the device serial numbers of CPE-A (2) and CPE-B (3), the original source IPv4 address of the data packets originated by CPE-A (2) and CPE-B (3) and the respective IPv6 addresses of data packets which has been written on XFF value by the load balancer (7).

7. A system according to claim 6, characterized by ACS (9) which is able to read IPv6 address corresponding to any CPE, such as CPE-A (2) and CPE-B (3), by using the related device serial number and forwarding the correct data packet to the correct CPE device.

8. A system according to claim 1, characterized by ACS (9) which originated data packets directly to the firewall (6) while reaching CPE-A (2) and CPE-B (3) for service activation, management and monitoring purposes.

9. A system according to claim 8, characterized by firewall (6) which receives data packet and transmits it to the related partition of CGN (5) over VLAN and which modifies the source IPv6 address value of the data packet (Source NAT) and replaces the IPv6 address of the load balancer with this source IPv6 address so that CGN (5) will be able to conduct the reverse process of network address translation which has occurred during the data packet transmission from CPE-A (2) and CPE-B (3) to ACS (9).

10. A system according to claim 9, characterized by CGN (5) which extracts the data packet based on V LAN number over which the data packet has been transmitted; receives the data packet from the related partition; translates IPv6 address in the data packet to IPv4 address for both source and destination addresses so that CPE-A (2) and CPE-B (3) can receive data packet in IPv4 format as they expected to receive.

11. A system according to claim 1, characterized by ACS (9) which is enabled to communicate with OSS/BSS layer and CRM and call center application on OSS/BSS layer over IPv4.
